(19) United States
(12) Patent Application Publication
(10) Pub. No.: US 2024/0337803 A1
(43) Pub. Date: Oct. 10, 2024

(54) PANEL SYSTEMS WITH SLIDABLE CASSETTES

(71) Applicant: CommScope Technologies LLC, Hickory, NC (US)

(72) Inventor: David Jan Irma VAN BAELEN, Winksele (BE)

(73) Assignee: CommScope Technologies LLC, Hickory, NC (US)

(21) Appl. No.: 18/293,127

(22) PCT Filed: Jul. 27, 2022
(86) PCT No.: PCT/US2022/038535

§ 371 Date: Jan. 29, 2024

Related U.S. Application Data
(60) Provisional application No. 63/227,403, filed on Jul. 30, 2021.

(51) Int. Cl. G02B 6/44

(52) U.S. Cl. CPC G02B 6/4453; G02B 6/4452

(57) ABSTRACT

A termination panel is configured to receive a single row of cassettes with each cassette spanning a majority of an interior height of the termination panel. Each cassettes carries multiple columns of front port members. Either the front port members or retainers of the front port members are flush with the cassette. Retainers of the rear port members also may be flush with the cassette. The cassette includes an internal fiber manager to organize fibers extending internally through the cassette.

### CROSS-REFERENCE TO RELATED APPLICATION

This application is being filed on Jul. 27, 2022 as a PCT International Patent Application and claims the benefit of U.S. Patent Application Ser. No. 63/227,403, filed on Jul. 30, 2021, the disclosure of which is incorporated herein by reference in its entirety.

### BACKGROUND

In the telecommunications industry, the demand for added capacity is growing rapidly. This demand is being met in part by the increasing use and density of fiber optic transmission equipment. Even though fiber optic equipment permits higher levels of transmission in the same or smaller footprint than traditional copper transmission equipment, the demand requires even higher levels of fiber density. This has led to the development of high-density fiber handling equipment.

In communications panel systems, port members (e.g., optical adapters, electrical jacks, hybrid port members, etc.) defining front ports are mounted to one or more trays that are disposable within a chassis. The front ports are configured to receive plug connectors at the fronts of the trays. The trays can either be stationary within a chassis or can slide forwardly of the chassis to enhance access to the port members.

Improvements are desired.

### SUMMARY

Some aspects of the disclosure are directed to a cassette configured to carry multiple rows or columns of front port members. In certain examples, the cassette carries at least three rows of front port members or carries multiple columns of at least three port members each. In certain examples, the cassette carries at least four rows of front port members or carries multiple columns of at least four port members each. In various examples, the front port members include fiber optic adapters, electrical plug sockets, hybrid plug adapters, etc. In certain implementations, the front port members are configured to receive multiple multi-fiber plug connectors. In various examples, the front port members are configured to receive duplex LC plug connectors, SN plug connectors, or MDC plug connectors.

In some implementations, front port members are flush with a remainder of the cassette. In other implementations, a retainer to which the front port members are pre-mounted is flush with the remainder of the cassette. In certain examples, the retainer snap-fits to the cassette. In certain implementations, the cassette carries one or more rear port members. In certain examples, the rear port members are pre-mounted to a retainer that mounts flush with a remainder of the cassette.

In certain implementations, the cassette includes an internal fiber manager to organize fibers extending internally through the cassette. In certain examples, the fiber manager is configured to facilitate storage of excess length of the optical fibers in one or more coils. In some examples, the fiber manager stores the coils horizontally. In other examples, the fiber manager stores the coils vertically.

In some implementations, the cassette carries a latching arrangement including a forward handle. In certain examples, the latching arrangement also includes a rearward handle. In other implementations, the cassette carries part of an interlock arrangement and a forward pull handle. In certain examples, the cassette also includes a rearward pull handle.

In certain implementations, the termination panel is configured to receive at least 192f connections within a 1 RU space. In certain examples, the termination panel is configured to receive at least 96 duplex fiber plug connectors within a 1 RU space. In certain examples, the duplex fiber plug connector includes a duplex LC plug connector. In certain implementations, the termination panel is configured to receive at least 384f connections within a 1 RU space. In certain examples, the termination panel is configured to receive at least 192 duplex fiber plug connectors within a 1 RU space. In certain examples, the duplex fiber plug connector includes an SN plug connector or an MDC plug connector. In certain implementations, the termination panel is configured to receive at least 432f connections within a 1 RU space. In certain examples, the termination panel is configured to receive at least 216 duplex fiber plug connectors within a 1 RU space. In certain examples, the duplex fiber plug connector includes an SN plug connector or an MDC plug connector.

In certain implementations, the termination panel is configured to receive a single row of cassettes with each cassette spanning a majority of an interior height of the termination panel. In certain examples, the termination panel includes a row of guides mounted to a bottom surface of the termination panel. In some examples, the cassettes are configured to latch to the guides at a predetermined position. In other examples, the cassettes slidingly interlock with the guides, but do not latch into a fixed position. In certain examples, the cassettes can be mounted to and removed from the guides from either the front or rear of the termination panel at a discretion of the user.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a front perspective view of a first example implementation of a cassette configured in accordance with the principles of the present disclosure and carrying one or more columns of front port members;

FIG. 2 is a rear perspective view of the first cassette of FIG. 1;

FIG. 3 shows the cover of the first cassette of FIG. 1 exploded upwardly to reveal the interior;

FIG. 4 is a top perspective view of the first cassette of FIG. 1 with the cover removed;

FIG. 5 is a front perspective view of the first cassette of FIG. 1 with the components exploded from each other;

FIG. 6 is a rear perspective view of the exploded first cassette of FIG. 5;

FIG. 7 is a bottom perspective view of the cover of the first cassette of FIG. 1;

FIG. 8 is a front perspective view of a second example implementation of a cassette configured in accordance with the principles of the present disclosure and carrying one or more columns of front port members;

FIG. 9 is an exploded view of the second cassette of FIG. 8;

FIG. 10 is a rear perspective view of a first retainer holding the front port members of the second cassette of FIG. 8;

FIG. 11 is a bottom perspective view of the second cassette of FIG. 9;

FIG. 12 is a front perspective view of a third example implementation of a cassette configured in accordance with the principles of the present disclosure and carrying one or more columns of front port members, two of the front port members shown exploded forwardly from the first retainer;

FIG. 13 is an exploded view of the third cassette of FIG. 12;

FIG. 14 is a bottom, front perspective view of a fourth example implementation of a cassette configured in accordance with the principles of the present disclosure and carrying one or more columns of front port members;

FIG. 15 is a top, rear perspective view of the fourth cassette of FIG. 14;

FIG. 16 is a top view of the fourth cassette of FIG. 14 with the components exploded away from each other;

FIG. 17 is a bottom, rear perspective view of the fourth cassette of FIG. 16;

FIG. 18 is a front perspective view of a first example implementation of a termination panel configured in accordance with the principles of the present disclosure and configured to latchingly receive any of the cassettes disclosed herein;

FIG. 19 is a rear perspective view of the first termination panel of FIG. 18;

FIG. 20 is an exploded view of the first termination panel of FIG. 18;

FIG. 21 shows the first termination panel of FIG. 18 partially populated with cassettes so that some of the guides are visible;

FIG. 22 is a front perspective view of a second example implementation of a termination panel configured in accordance with the principles of the present disclosure;

FIG. 23 is a rear perspective view of the second termination panel of FIG. 22;

FIG. 24 is a front perspective view of a third example implementation of a termination panel configured in accordance with the principles of the present disclosure;

FIG. 25 is a rear perspective view of the third termination panel of FIG. 24;

FIG. 26 shows the third termination panel of FIG. 24 partially populated with cassettes so that some of the guides are visible; and

FIG. 27 is an exploded view of the third termination panel of FIG. 24.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

A fiber cassette 100, 200, 300, 400 includes a cassette body 102, 202, 302, 402 carrying a plurality of front port members 104, 204, 304, 404. The cassette body 102, 202, 302, 402 extends along a length L between a front end 110, 210, 310, 410 and a rear end 112, 212, 312, 412, along a width W between a first side 114, 214, 314, 414 and an opposite second side 116, 216, 316, 416, and along a height H between a bottom 118, 218, 318, 418 and an opposite top 120, 220, 320, 420. In certain implementations, the cassette body 102, 202, 302, 402 is elongate along the length L. In certain implementations, the cassette body 102, 202, 302, 402 is elongate along the width W. In certain implementations, the cassette body 102, 202, 302, 402 is elongate along the height H.

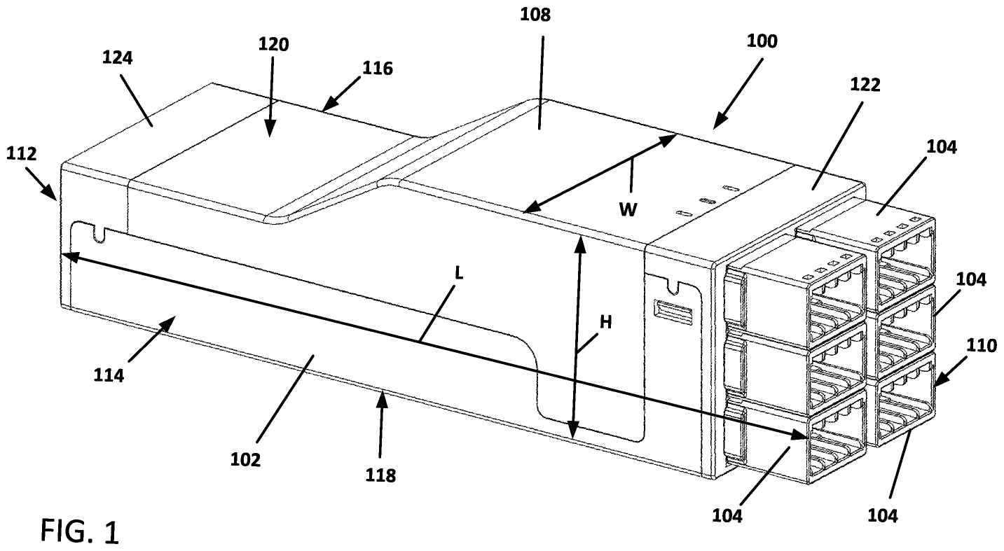

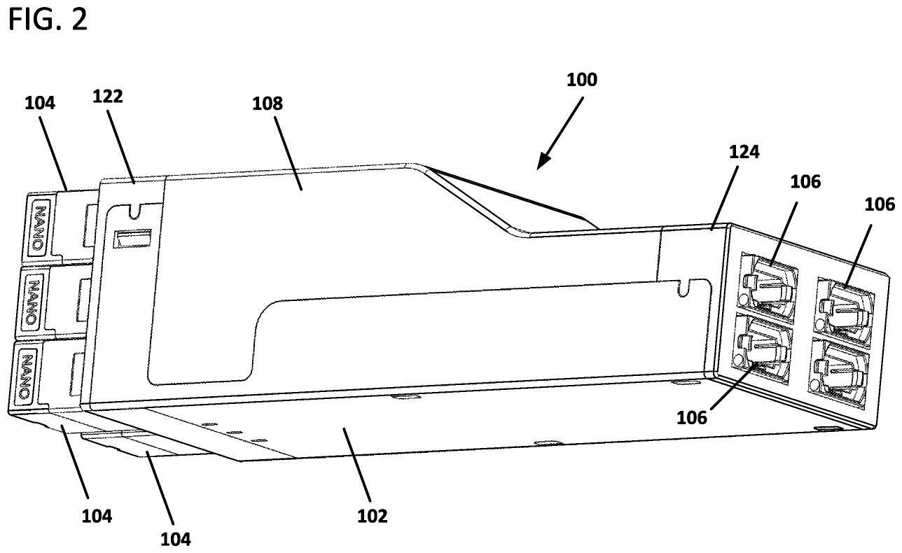

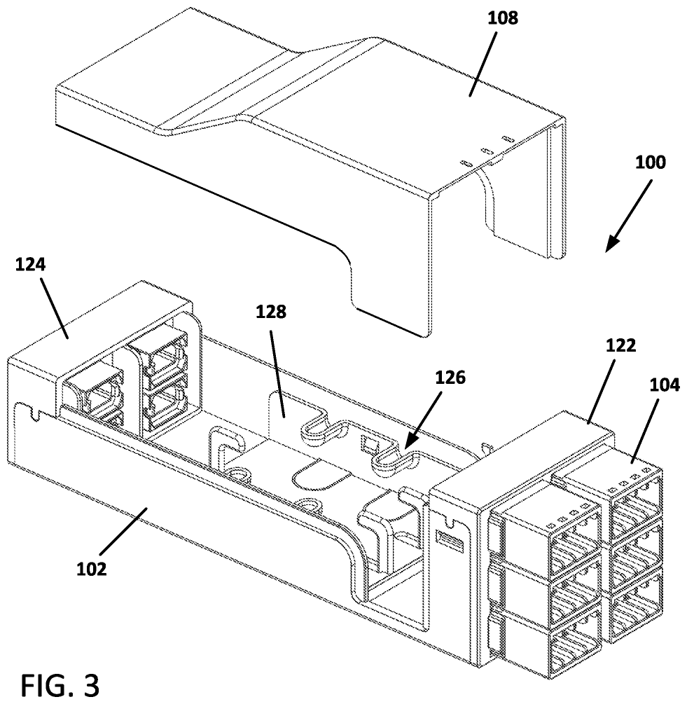

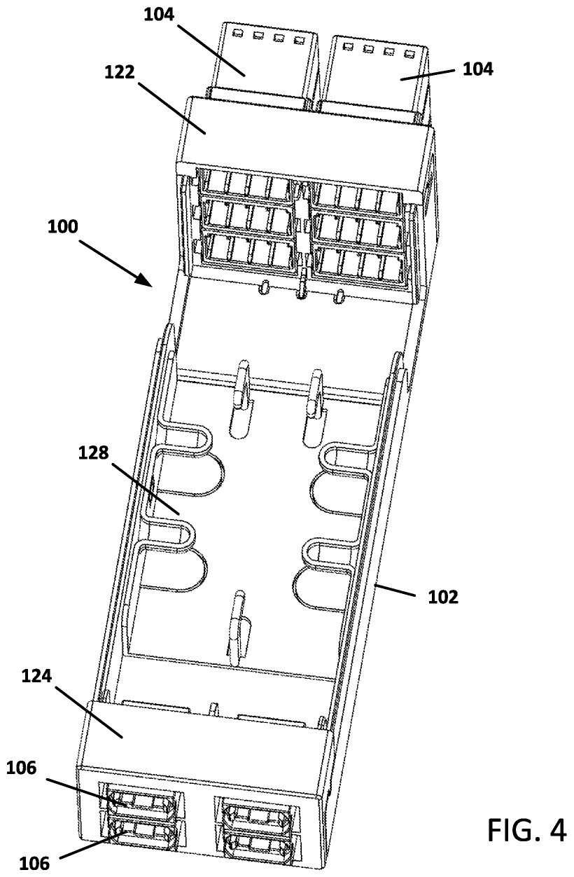

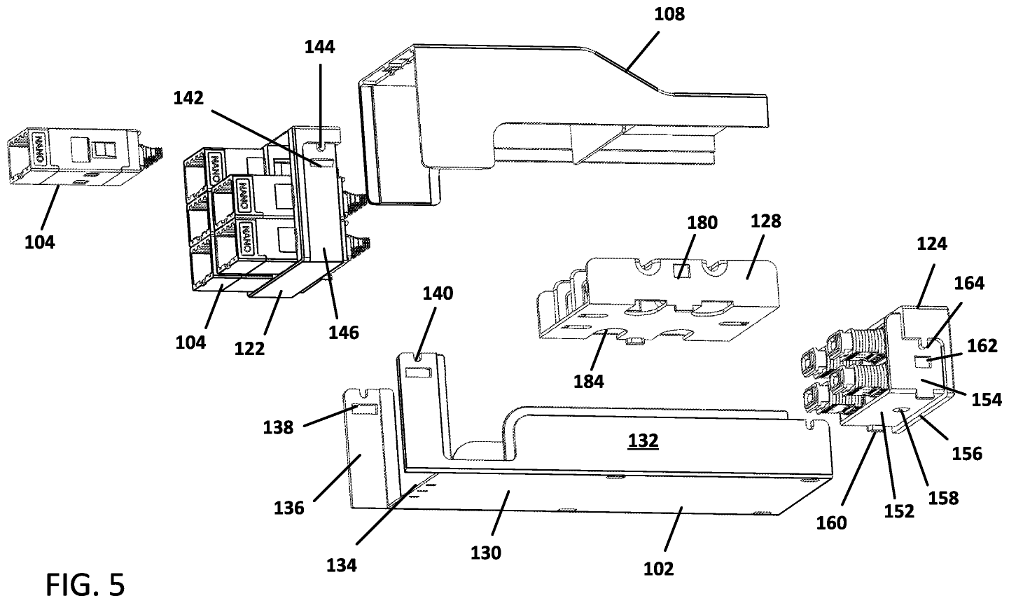

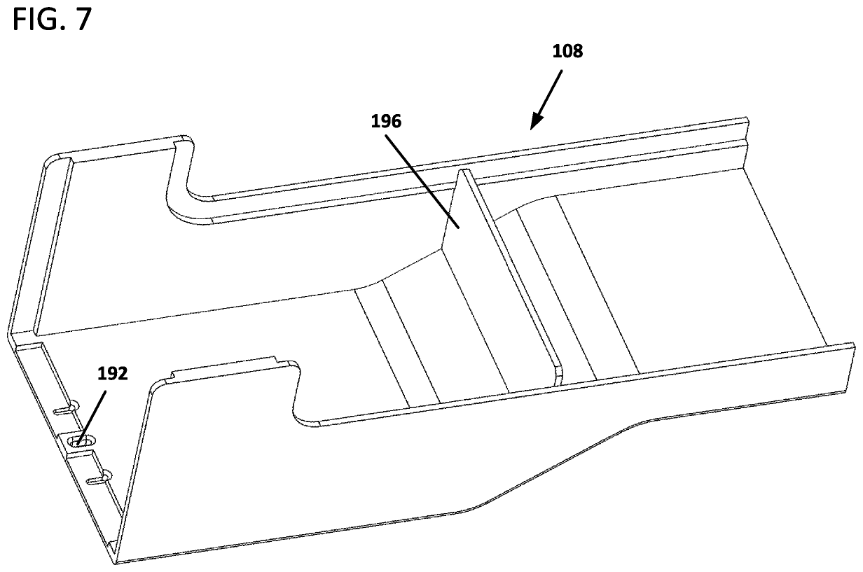

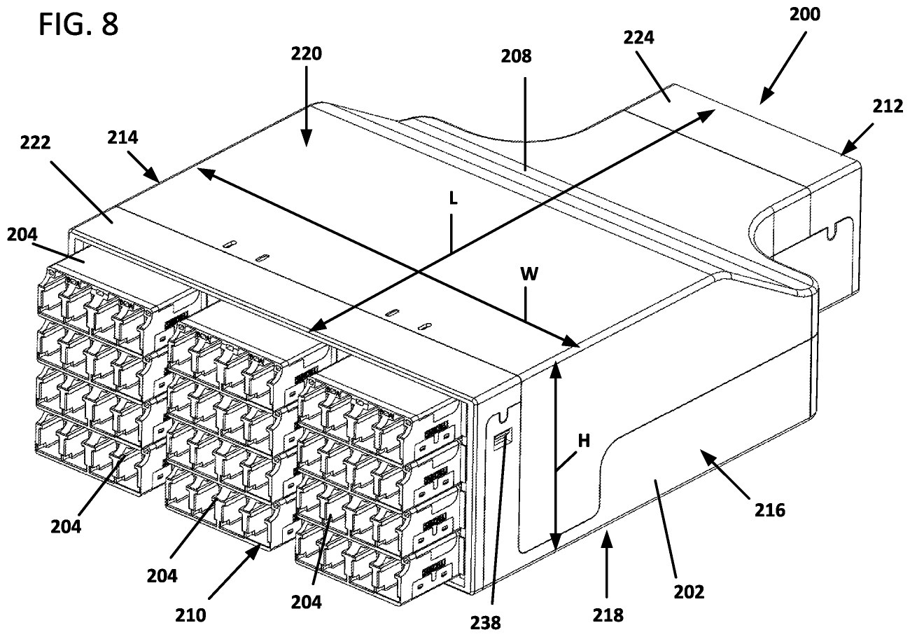

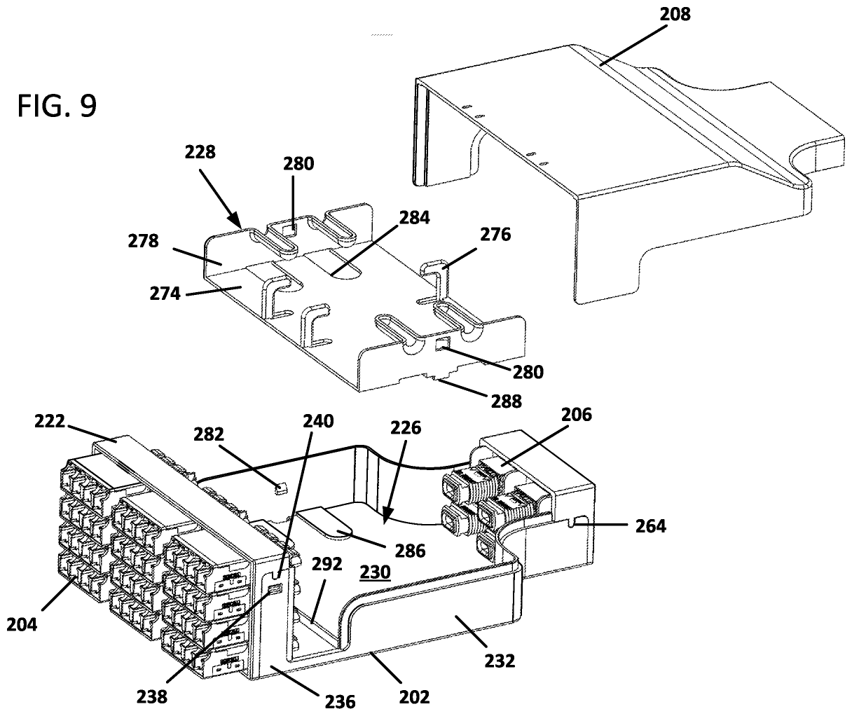

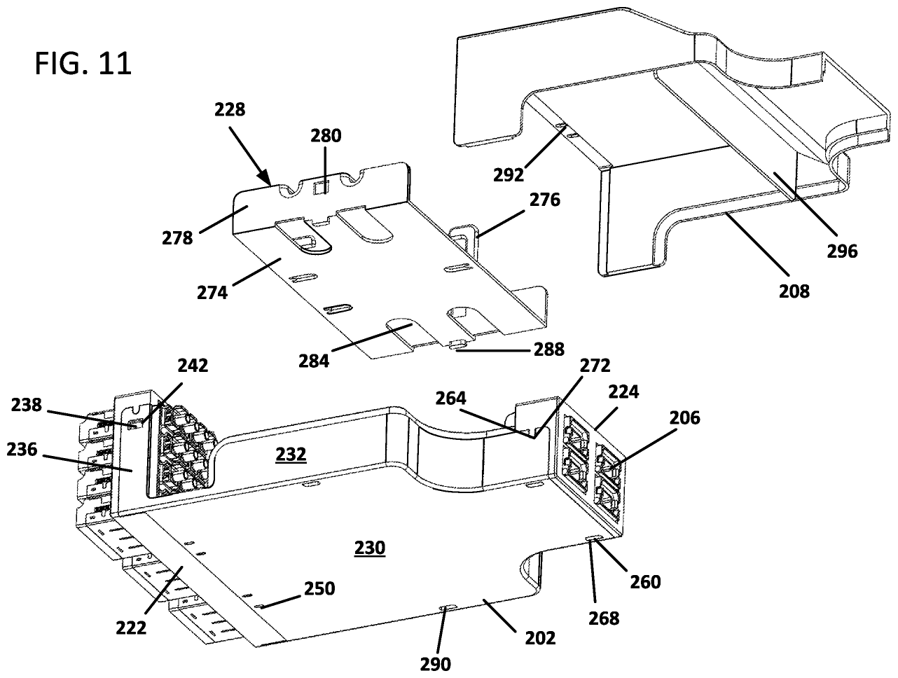

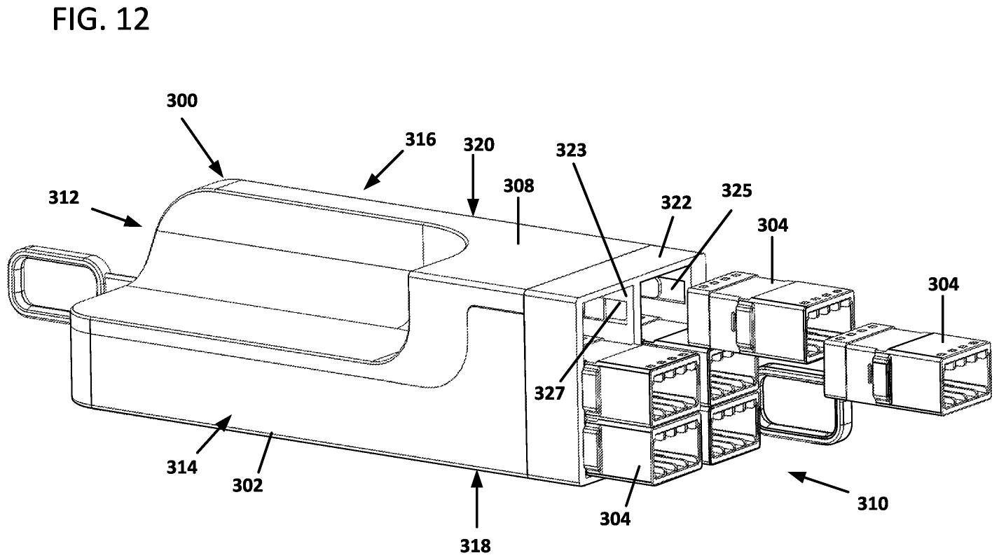

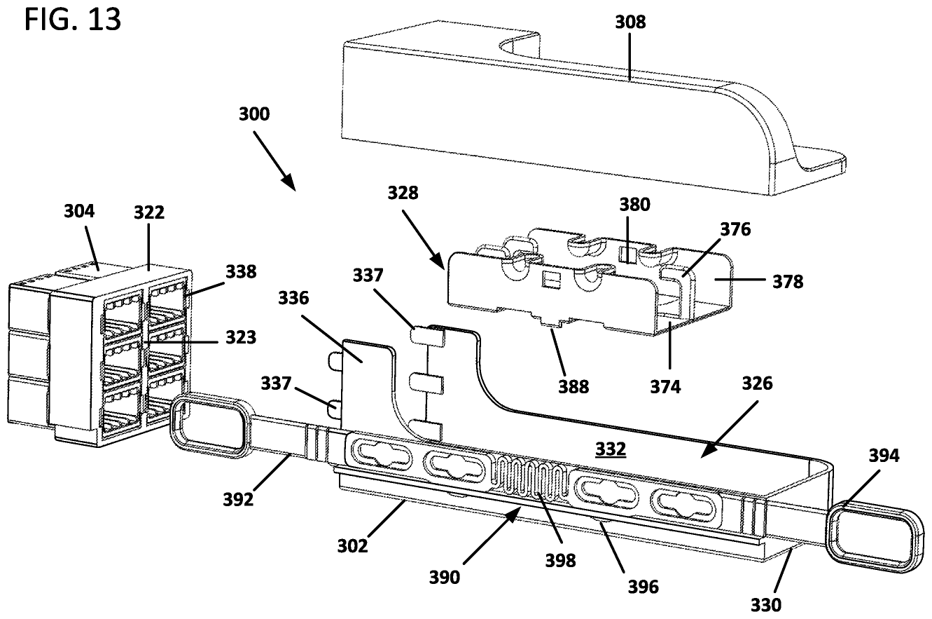

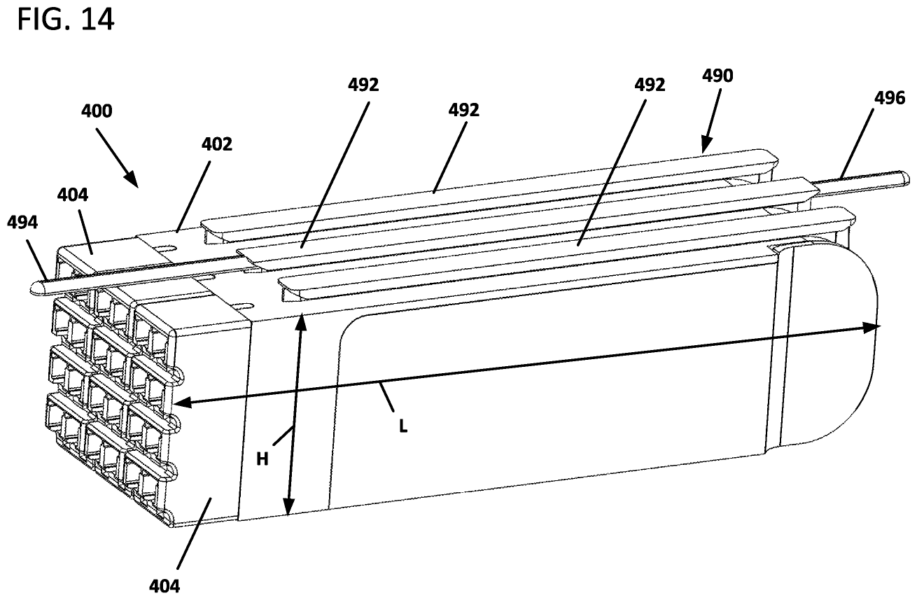

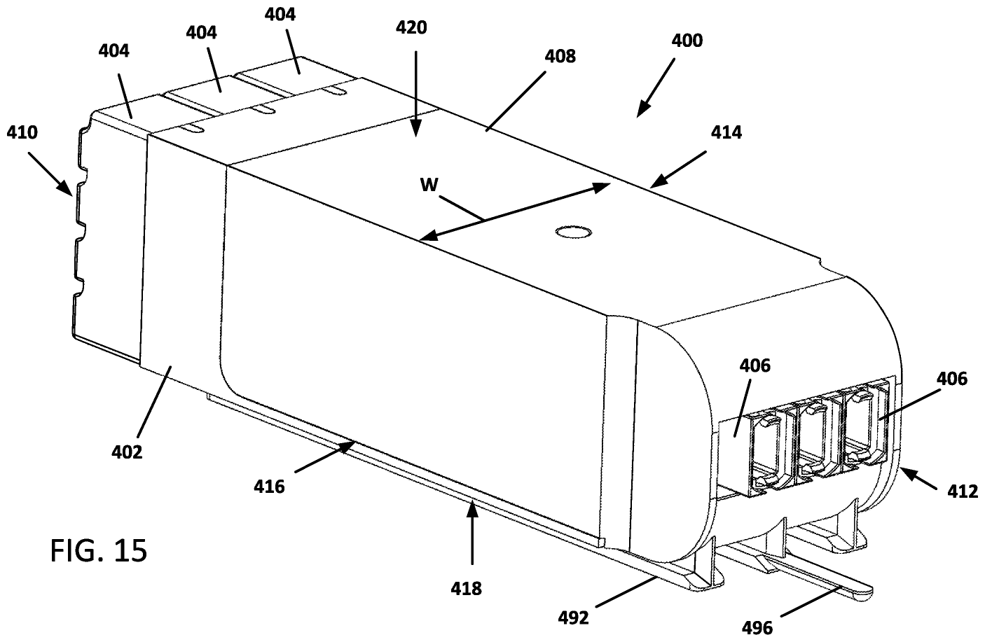

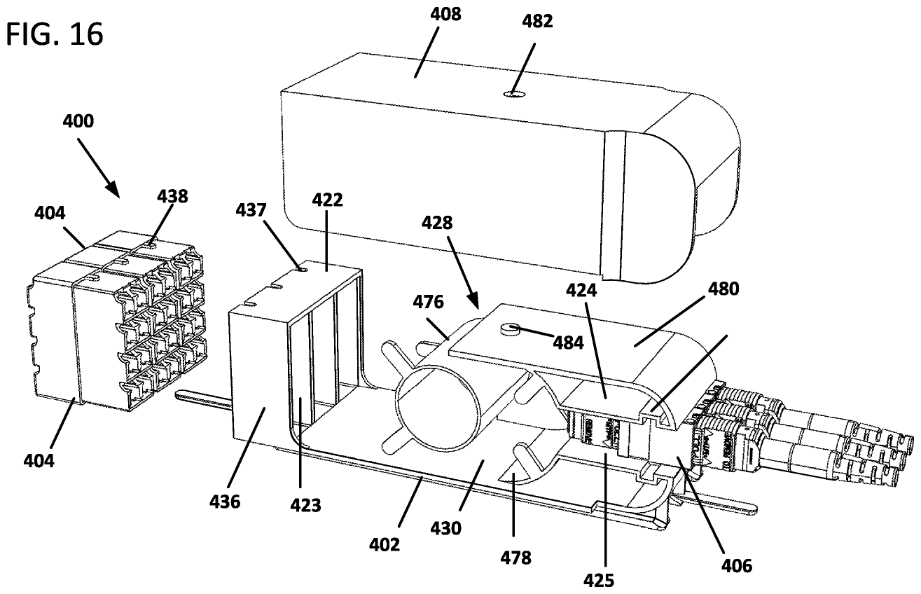

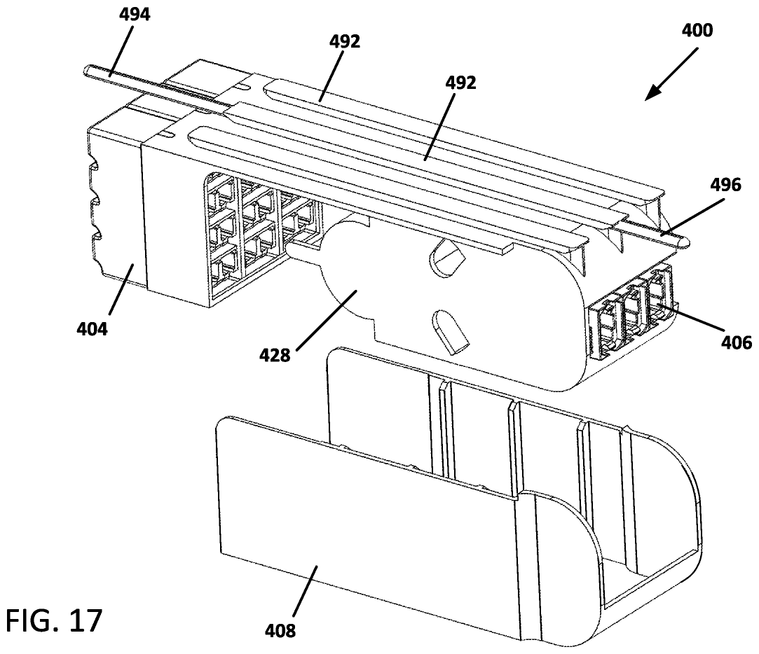

FIGS. 1-7 illustrate a first example cassette 100 configured in accordance with the principles of the present disclosure. In the example shown, the first cassette 100 carries multiple columns of vertically-oriented SN or MDC front port members 104. FIGS. 8-11 illustrate a second example cassette 200 configured in accordance with the principles of the present disclosure. In the example shown, the second cassette 200 carries multiple columns of horizontally-oriented duplex-LC front port members 104. FIGS. 12-13 illustrate a third example cassette 300 configured in accordance with the principles of the present disclosure. In the example shown, the third cassette 300 is similar to the first cassette 100, but includes a different front port retainer and carries an example latching arrangement. FIGS. 14-17 illustrate a fourth example cassette 400 configured in accordance with the principles of the present disclosure. In the example shown, the fourth cassette 400 has a different front port retainer and a different fiber manager from the other cassettes 100, 200, 300. The fourth cassette 400 also carries an interlock arrangement

In certain examples, the front port members 104, 204, 304, 404 define front ports accessible from an exterior of the cassette body 102, 202, 302, 402 and rear ports accessible from an interior of the cassette body 102, 202, 302, 402. In certain examples, the cassette body 102, 202, 302, 402 may include or carry a fiber manager 128, 228, 328, 428 to organize excess length of fibers within the cassette 100, 200, 300, 400. In some examples, the interior of the cassette body 102, 202, 302, 402 is enclosed by a cassette cover 108, 208, 308, 408. In other examples, the interior of the cassette body 102, 202, 302, 402 has an open top.

In some examples, the cassette body 102, 202, 302, 402 may carry one or more rear port members 106, 206, 406 having rear ports accessible from the exterior of the cassette body 102, 202, 302, 402 and front ports accessible from the interior of the cassette body 102, 202, 302, 402. The rear port members 106, 206, 406 may be configured to receive a different type of plug connector than the front port members 104, 204, 404. For example, the rear port members 106, 206, 406 may be configured to receive MPO plug connectors while the front port members 104, 204, 404 are configured to receive SN plug connectors, MDC plug connector, or duplex-LC plug connectors. In other examples, the cassette 100, 200, 300, 400 is configured to receive an optical cable carrying one or more fibers that are transitioned out of the cable within the cassette body 102, 202, 302, 402 and plugged into the rear ports of the front port members 104, 204, 404. In still other examples, the cassette 100, 200, 300, 400 is configured to receive a plurality of connectorized optical fibers that extend through the cassette to the rear ports of the front port members 104, 204, 404. In other implementations, internal optical fibers may be routed through the interior of the cassette between one or more of the rear ports of the front port members 104, 204, 304, 404 to other rear ports of the front port members 104, 204, 304, 404.

In certain implementations, each cassette 100, 200, 300, 400 is configured to receive any of multiple types of front port members 104, 204, 304, 404. For example, a first type of front port member 104, 204, 304, 404 is configured to receive multiple SN plug connectors. A second type of front port member 104, 204, 304, 404 is configured to receive multiple duplex-LC plug connectors. A third type of front port member 104, 204, 304, 404 is configured to receive multiple MPO plug connectors. A fourth type of front port member 104, 204, 304, 404 is configured to receive multiple MDC plug connectors. In the examples shown, each of the port member types receive the respective plug connectors in a vertical orientation so that a widest portion of the plug connector extends along the height H of the cassette 102, 202, 302, 402 (e.g., see FIG. 1). Other configurations are possible. For example, the front port members 104, 204, 304, 404 may be configured to receive the respective plug connectors in a horizontal location (e.g., see FIG. 8). In other implementations, the front port members 104, 204, 304, 404 may be configured to receive single-fiber plug connectors, electrical plug connectors, or hybrid plug connectors. In other examples, the front port members 102, 202, 302, 402 are configured to receive and anchor cables fed into the cassette 100, 200, 300, 400.

The cassette body 102, 202, 302, 402 defines an interior 126, 226, 326, 426 that extends from the rear ports of the front port members 104, 204, 304, 404 to the front ports of the rear port member(s) 106, 206, 306, 406. In some implementations, the interior 126, 226, 326, 426 is enclosed by a cover 108, 208, 308, 408. In other implementations, the interior 126, 226, 326, 426 is accessible through an open top of the body 102, 202, 302, 402. In certain implementations, the fiber manager 128, 228, 328, 428 is disposed within the interior 126, 226, 326, 426 of the cassette body 102, 202, 302, 402. The fiber manager 128, 228, 328, 428 includes fiber management structures 176, 276, 376, 476 (e.g., bend radius limiters, spools, retention fingers, etc.) that facilitate storing excess length of fibers in one or more coils within the interior 126, 226, 326, 426.

In some examples, the fiber manager 128, 228, 328, 428 includes one or more fiber management members 176, 276, 376, 476 (e.g., fiber retention fingers, fiber spools, bend radius limiters, etc.). In certain examples, the fiber management members 176, 276, 376, 476 facilitate routing of the optical fibers between the front and rear port members. In certain examples, the fiber management members 176, 276, 376, 476 facilitate coiling of the optical fibers. In some examples, the fiber management members 176, 276, 376 facilitate winding the optical fibers in a horizontal coil. In other examples, the fiber management members 476 facilitate winding the optical fibers in a vertical coil.

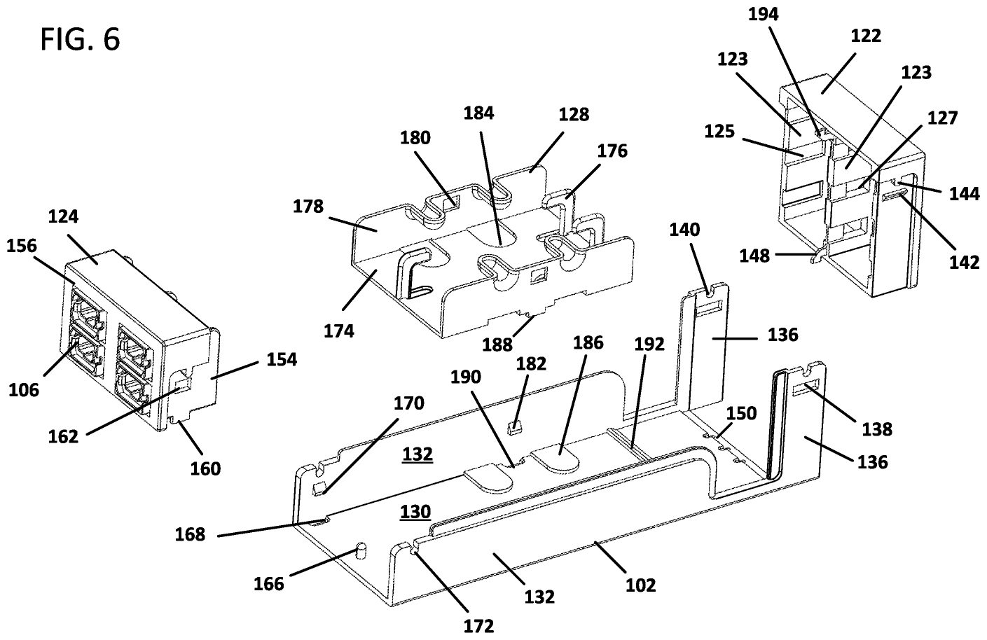

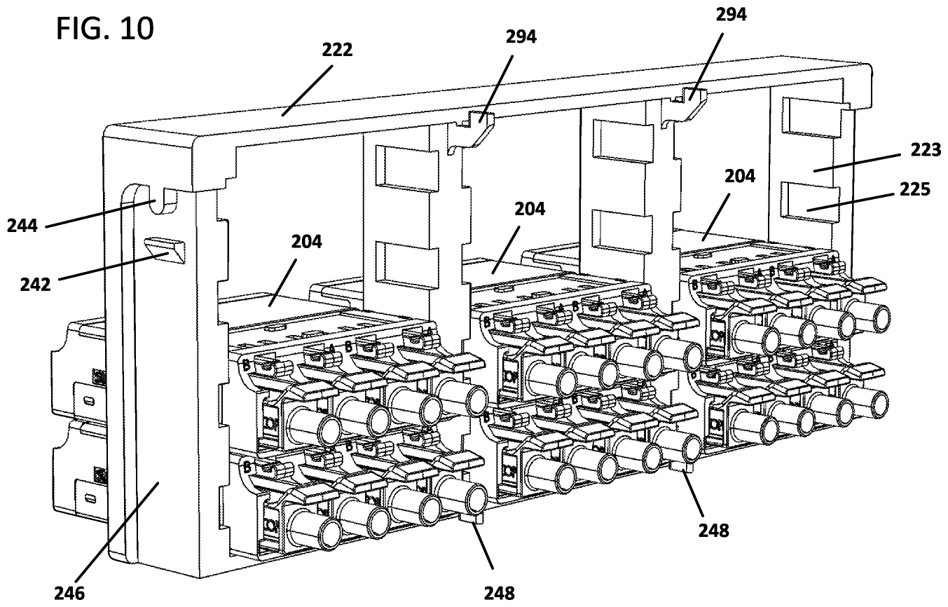

The cover 108, 208, 308, 408 is configured to mount to the body 102, 202, 302, 402 of the cassette 100, 200, 300, 400. In certain examples, the cover 108, 208, 308, 408 includes sidewalls configured to engage sidewalls 132, 232, 332, 432 of the body 102, 202, 302, 402. In certain implementations, the cover 108, 208, 308, 408 attaches to the cassette body 102, 202, 302, 402 to inhibit movement relative to the cassette body 102, 202, 302, 402 in one or more directions. For example, in some implementations, the cover 108, 208, 308 may define an aperture 192, 292 that receives a retention flange 194 (FIG. 6), 294 (FIG. 10) of the first retainer 122, 222, 322 to inhibit movement of the cover 108, 208, 308 along the length L and/or width W of the cassette 100, 200, 300 when attached. In other implementations, the cover 408 defines an aperture 482 that receives a peg 484 or other protrusion. In certain implementations, the cover 108, 208, 308 includes a blocking flange 196, 296 that aligns with a top of the fiber management tray 174, 274, 374. The blocking flange 196, 296 blocks the fibers from bypassing the fiber management tray 174, 274, 374.

In certain implementations, the height H of the cassette 100, 200, 300, 400 is less than 43 mm. In certain examples, the height H of the cassette 100, 200, 300, 400 is less than 42 mm. In certain examples, the height H of the cassette 100, 200, 300, 400 is less than 41.5 mm. In an example, the height H of the cassette is about 41 mm. In an example, the height H of the cassette 100, 200, 300, 400 is about 41.1 mm.

In some implementations, a termination arrangement including the front port members 104, 204, 304, 404 is flush-mounted with the cassette body 102, 202, 302, 402 (e.g., see FIGS. 1, 8, 12, and 14). In certain examples, the termination arrangement is flush-mounted with the cover 108, 208, 308, 408. At least portions of the front port members 104, 204, 304, 404 are disposed forward of a front edge of the floor 130, 230, 330, 430 of the cassette body 102, 202, 302. In some examples, a retention member 122, 222, 322 holding the front port members 104, 204, 304 is flush-mounted with the cassette body 102, 202, 302, 402. In such implementations, the front port members 104, 204, 304 may be fully disposed forward of a front edge of the floor 130, 230, 330 of the cassette body 102, 202, 302. In other examples, the front port members 404 themselves are flush with the cassette body 402.

### Fiber Manager

Referring to cassettes 100, 200, 300 of FIGS. 1-13, in some examples, the fiber manager 128, 228, 328 includes a separate tray 174, 274, 374 that carries the fiber management members 176, 276, 376 and mounts to the cassette body 102, 202, 302. In certain examples, the tray 174, 274, 374 spans an interior width of the cassette body 102, 202, 302. In certain implementations, the cassette body 102, 202, 302 includes a ramp 192, 292 disposed between the tray 174, 274, 374 and the first retainer 122, 222, 322. The ramp 192, 292 helps to guide fibers extending from rear ports of the front port members 104, 204, 304, over the ramp 192, 292, and onto the tray 174, 274, 374 without catching on the front side or edge of the tray 174, 274, 374.

In certain implementations, the fiber management tray 174, 274, 374 is configured to snap-fit or otherwise mount to the cassette body 102, 202, 302. In certain implementations, the fiber management tray 174, 274, 374 defines openings 184, 284 configured to receive protrusions 186, 286 extending upwardly from the cassette body 102, 202, 302 to inhibit movement of the fiber management tray 174, 274, 374 relative to the cassette body 102, 202, 302 along the length L and/or width W of the cassette 100, 200, 300. In certain examples, the fiber management tray 174, 274, 374 includes tabs 188, 288 that fit within slots 190 defined in the fiber management tray 174, 274, 374 to inhibit movement of the fiber management tray 174, 274, 374 relative to the cassette body 102, 202, 302 along the length L and/or width W of the cassette 100, 200, 300.

In certain implementations, the fiber management tray 174, 274, 374 includes sidewalls 178, 278, 378. In certain examples, the sidewalls 178, 278, 378 defines apertures 180, 280, 380 that receive latching tabs 182, 282 of the sidewalls 132 of the cassette body 102, 202, 302 to inhibit movement of the fiber management tray 174, 274, 374 relative to the cassette body 102, 202, 302 along the height H of the cassette body 102, 202, 302. For example, the sidewalls 178, 278, 378 of the fiber management tray 174, 274, 374 may flex or otherwise deflect inwardly to allow the apertures 180, 280, 380 to snap over the latching tabs 182, 282.

Referring to the cassette 400 of FIGS. 14-17, in other implementations, the fiber manager 428 is integrally formed with the cassette body 402. The fiber manager 428 includes a spool 476 around which excess length of one or more optical fibers can be vertically coiled. The spool 476 is disposed between the rear port members 406 and the front port members 404. In certain examples, the fiber manager 428 includes bend radius limiters 478 configured to guide fibers to the spool 476. In certain examples, the fiber manager 428 includes atop wall 480.

### Termination Arrangement Mounting

The front port members 104, 204, 304, 404 are mounted to the cassette body 102, 202, 302, 402 by a first port retainer 122, 222, 322, 422. In certain implementations, the first retainer 122, 222, 322, 422 holds the front port members 104, 204, 304, 404 in a plurality of rows. In certain examples, the first retainer 122, 222, 322, 422 holds the front port members 104, 204, 304, 404 in a plurality of columns with each column including a plurality of front port members 104, 204, 304, 404. In certain examples, the first retainer 122, 222, 322, 422 defines cavities bounded by walls 123, 223, 323, 423 and open at the front and rear ends of the first retainer 122, 222, 322, 422. In certain examples, multiple front port members 104, 204, 304, 404 are disposed in a column in each cavity. In certain examples, adjacent front port members 104, 204, 304, 404 in each column directly oppose each other.

In some implementations, the first retainer 422 is integrally formed with the cassette housing 402. For example, in certain implementations, the first retainer 422 extends forwardly from the floor 430 of the cassette body 402. In certain examples, portions of the front port members 404 are recessed to fit within the first retainer 422 while other portions extend forwardly of the first retainer 422. In the example shown, the forwardly-extending portions of the front port members 404 are flush with the first retainer 422 (e.g., see FIG. 14). In certain examples, the forwardly-extending portions of the front port members 404 are flush with the body 402 and/or cover 408 of the cassette 400. In certain examples, the front port members 404 include guide protrusions 438 that fit within slots 437 defined in the first retainer 422. In certain examples, the front port members 404 may latch to the first retainer 422.

In other implementations, the front port members 104, 204, 304 are pre-mounted to the retainer 122, 222, 322 before the retainer 122, 222, 322 is mounted to the cassette body 102, 202, 302. In certain implementations, the front port members 104, 204, 304 are configured to snap-fit to the first retainer 122, 222, 322. In certain examples, each wall 123, 223, 323 defines a plurality of recesses 125, 225, 325 in which portions (e.g., latching tabs, alignment guides, etc.) of the front port members 104, 204, 304 are received when the front port members 104, 204, 304 are mounted to the first retainer 122, 222, 322. In certain examples, an aperture 127, 327 may be defined within one or more of the recesses 125, 225, 325. For example, the apertures 127, 327 may be defined in the recesses 125, 225, 325 of an inner wall 123, 223, 323, but not in the recesses 125, 225, 325 of the outer walls 123, 223, 323. The apertures 127, 327 may receive latching tabs or other mounting structures of the front port members 104, 204, 304.

In certain implementations, the cassette body 102, 202, 302 includes opposite sidewalls 132, 232, 332 extending upwardly from a floor 130, 230, 330. In certain implementations, the retainer 122, 222, 322 mounts flush with the floor 130, 230, 330 and sidewalls 132, 232, 332 of the cassette body 102, 202, 302. In certain implementations, the retainer 122, 222, 322 mounts flush with the cover 108, 208, 308 of the cassette body 102, 202, 302. In some implementations, the first retainer 122, 222 is configured to snap-fit to the cassette body 102, 202 as will be described in more detail below. Other mounting configurations are possible. For example, the first retainer 322 is configured to slot into, dovetail, or otherwise interlock with the cassette body 302 as will be described in more detail below.

In certain implementations, one or more rear port members 106, 206, 406 are mounted to the cassette body 102, 202, 302, 402. It is noted that while the cassette 300 is shown without rear port members, it will be understood that the cassette body 302 could carry rear port members. In certain implementations, the rear port members 106, 206 are mounted to the cassette body 102, 202 by a second port retainer 124, 224, 424. In certain implementations, the second retainer 124, 224, 424 holds the rear port members 106, 206, 406 in a plurality of rows. In certain examples, the second retainers 124, 224, 424 holds the rear port members 106, 206, 406 in a plurality of columns with each column including a plurality of rear port members 106, 206, 406.

In some implementations, the second retainer 424 is integral with the cassette body 402 and/or the fiber manager 428. For example, the rear port members 406 may be laterally inserted into a mounting cavity 425 configured to inhibit movement of the rear port members 406 along the length L and/or height H of the cassette 400. In certain examples, the cover 408 may inhibit movement of the rear port members 406 along the width W of the cassette 400 when mounted to the body 402.

In other implementations, the rear port members 106, 206 are pre-mounted to the second retainer 124, 224 before the second retainer 124, 224 is mounted to the cassette body 102, 202. In certain implementations, the second retainer 124, 224 mounts flush with the floor 130, 230 and sidewalls 132, 232 of the cassette body 102, 202. In certain implementations, the second retainer 124, 224 mounts flush with the cover 108, 208 of the cassette body 102, 202 (e.g., see FIGS. 1 and 8). In certain examples, the rear port members 106, 206 are configured to snap-fit to the second retainer 124, 224. In certain examples, the rear port members 106, 206 mount to the second port retainer 124, 224 in the same manner than the front port members 104, 204, 304 mount to the first port retainer 122, 222, 322. In certain implementations, the second retainer 124, 224 is configured to snap-fit to the cassette body 102, 202 as will be described in more detail below. Other mounting configurations are possible such as the interlock mounting arrangement of the first retainer 322 to the cassette housing 302.

In certain implementations, one of the retainer 122, 222, 322, 124, 224 and the cassette body 102, 202, 302 includes latching tabs while the other defines a catch surface. The latching tabs are configured to snap-fit into an aperture defined at least partially by the catch surface. In some examples, the retainers 122, 222, 322, 124, 224 carry latching tabs 142, 242, 342 while the cassette body 102, 202, 302 defines the catch surfaces 138, 238. In other examples, the cassette body 102, 202, 302 defines the latching tabs 170 and the retainers 122, 222, 124, 224 define the catch surfaces 162. In the examples shown, the front retainer 122, 222, 322 carries the latching tabs 142, 242 and the cassette body 102, 202, 302 carries the catch surfaces 138, 238; the rear retainer 124, 224 defines the catch surfaces 162 and the cassette body 102, 202 carries the latching tabs 170.

In certain implementations, the cassette body 102, 202, 302 is configured to receive the retainer 122, 222, 322 forward of the front edge 134 of the floor 130, 230, 330. In certain examples, retention arms 136, 236, 336 are disposed forwardly of the front edge 134, 234, 334 of the floor 130, 230, 330. The first retainer 122, 222, 322 is mounted to the retention arms 136, 236, 336 to inhibit movement of the front port members 104, 204, 304 relative to the cassette body 102, 202, 302 along the length L, width W, and height H of the cassette 100, 200, 300.

In some implementations, each retention arm 136, 236 defines a catch surface 138, 238. For example, each retention arm 136, 236 may define an aperture bounded by the catch surface 138, 238. The retainer 122, 222 includes side tabs 142, 242 configured to engage the catch surfaces 138, 238 of the arms 136, 236 to inhibit remove of the retainer 122, 222 from the cassette body 102, 202 along the height H of the cassette 100, 200. In certain examples, each retention arm 136, 236 defines a notch 140, 240. In certain examples, the retainer 122, 222 includes protrusions 144, 244 that fit within the notches 140, 240 of the retention arms 136, 236 of the cassette body 102, 202 to inhibit movement of the retainer 122, 222 relative to the cassette body 102, 202 along the length L of the cassette 100, 200. In certain examples, the retainer 122, 222 defines side recesses 146, 246 in which the side tabs 142, 242 and protrusions 144, 244 are disposed. In certain examples, the retention arms 136, 236 fit within the side recesses 146, 246. In certain examples, the retainer 122, 222 includes a rearward tab 148, 248 that fits within an aperture 150, 250 defined in the floor 130, 230 of the cassette body 102, 202 to further inhibit movement along the length L and/or width W of the cassette 100, 200.

In other implementations, each retention arm 336 includes forward protrusions 337 that are received in slots 338 defined in the first retainer 322. In certain examples, the protrusions 337 may dovetail or otherwise interlock with the slots 338. In certain examples, the protrusions 337 inhibit movement of the first retainer 322 relative to the cassette body 302 along the width W and height H of the cassette 300. In certain examples, friction between the protrusions 337 and the slots 338 inhibits relative movement along the length L of the cassette 300. Other configurations are possible. For example, the protrusions 337 latch to the slots 338. Of course, the retention arms 336 may define the slots while the first retainer 322 includes the protrusions.

In certain implementations, the second retainer 124, 224 defines recesses 152, 154 at the bottom and sides, respectively, that allow the second retainer 124, 224 to seat on the floor 130, 230 of the cassette body 102, 202 while a rear section 156, 235 of the second retainer 124, 224 extends flush with the floor 130, 230 and sidewalls 132, 232. In certain implementations, the second retainer 124, 224 defines a catch surface 162 configured to engage inwardly-facing side tabs 170 of the cassette body 102, 202 to inhibit upwardly movement of the second retainer 124, 224 relative to the cassette body 102, 202 along the height H of the cassette 100, 200. In certain examples, the cassette body 102, 202 defines a notch 172, 272 configured to receive a protrusion 164, 264 of the second retainer 124, 224 to inhibit movement of the second retainer 124, 224 along the length L of the cassette 100, 200.

In certain examples, the second retainer 124, 224 defines a hole 158 configured to fit with a peg 166 extending upwardly from the floor 130, 230 to inhibit movement of the second retainer 124, 224 relative to the cassette body 102, 202 along the length L of the cassette 100, 200 and/or along the width W of the cassette 100, 200. In certain examples, the second retainer 124, 224 includes downwardly extending tabs 160, 260 that fit within slots 168, 268 defined in the floor 130, 230 of the cassette body 102, 202. Engagement between the tabs 160, 260 and the slots 168, 268 inhibits movement along the length L of the cassette 100, 200 and/or along the width W of the cassette 100, 200.

### Panel Structure

The cassettes 100, 200, 300, 400 described herein may be mounted within a termination panel 500, 600, 700. Each termination panel 500, 600, 700 has a depth D extending between a front end 504, 604, 704 and a rear end 506, 606, 706 of the panel 500, 600, 700 and a width W2 extending between a first side 508, 608, 708 and a second side 510, 610, 710 of the panel 500, 600, 700. Each cassette 100, 200, 300, 400 extends along at least a majority of the depth D of the termination panel 500, 600, 700. Each cassettes 100, 200, 300, 400 has a height H extending along at least a majority of a height H2 of an interior 516, 716 of the termination panel 500, 600, 700. In certain examples, the height H2 of the termination panel 500, 600, 700 is a standard rack unit (i.e., 1 RU). Other sizes are possible. The cassettes 100, 200, 300, 400 are disposed in a row along the width W2 of the termination panel 500, 600, 700.

In certain implementations, the panel 500, 600, 700 includes a bottom panel 524, 624, 724, a top panel 526, 626, 726 mounted to the bottom panel 524, 624, 724, and opposite sidewalls 528, 628, 728 extending between the top and bottom panels. In some examples, the sidewalls 528, 628 are integrally formed with the top panel 526. In other examples, the sidewalls 728 are integrally formed with the bottom panel 724. In other examples, the sidewalls 528, 628, 728 may be separately formed from both the top and bottom panels. The sidewalls 528, 628, 728 carry rack mounting flanges 530, 630, 730. In certain implementations, inner surfaces of the sidewalls 528, 628, 728 do not include guiding or latching structure configured to engage the cassettes 100, 200, 300, 400.

In certain implementations, guides 518, 718 are fixedly mounted to the termination panel 500, 600, 700 at the bottom 512, 612, 712. In certain examples, the guides 518, 718 are mounted to an inner surface of a bottom panel, which defines the bottom 512, 612, 712 of the termination panel 500, 600, 700. The guides 518, 718 are laterally spaced from each other along the width W2 of the termination panel 500, 600, 700. Each guide 518, 718 is elongate along the depth D of the termination panel 500, 600, 700. The cassettes 100, 200, 300, 400 are configured to engage the guides 518, 718 to mount the cassettes 100, 200, 300, 400 within the termination panel 500, 600, 700. In certain examples, the cassettes 100, 200, 300, 400 can slide into the termination panel 500, 600, 700 along the guides 518, 718 from the front 504, 604, 704 and/or from the rear 506, 606, 706 of the termination panel 500, 600, 700.

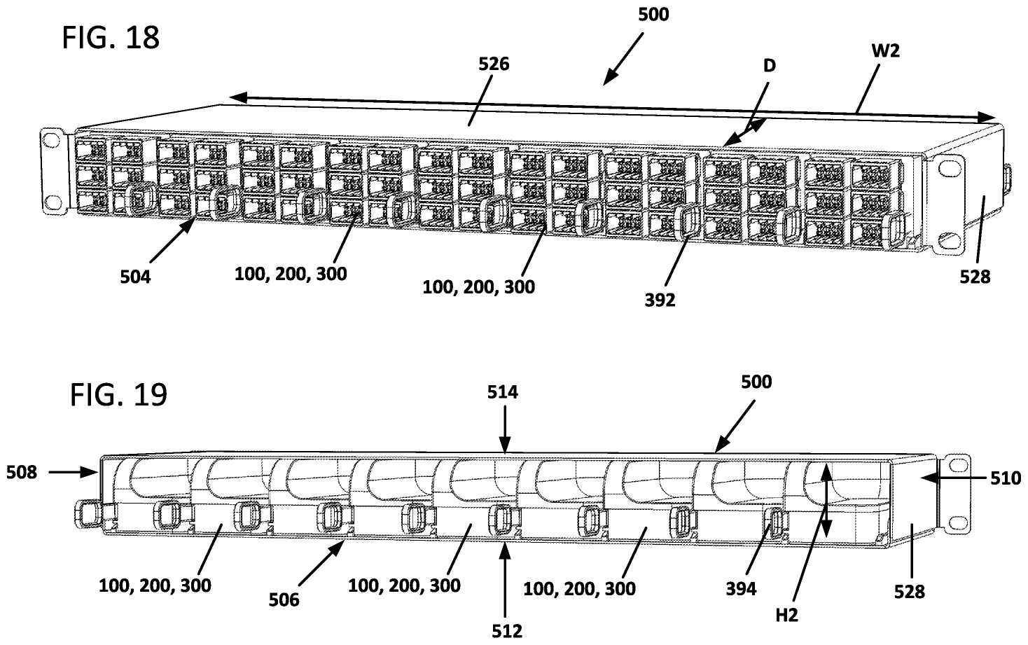

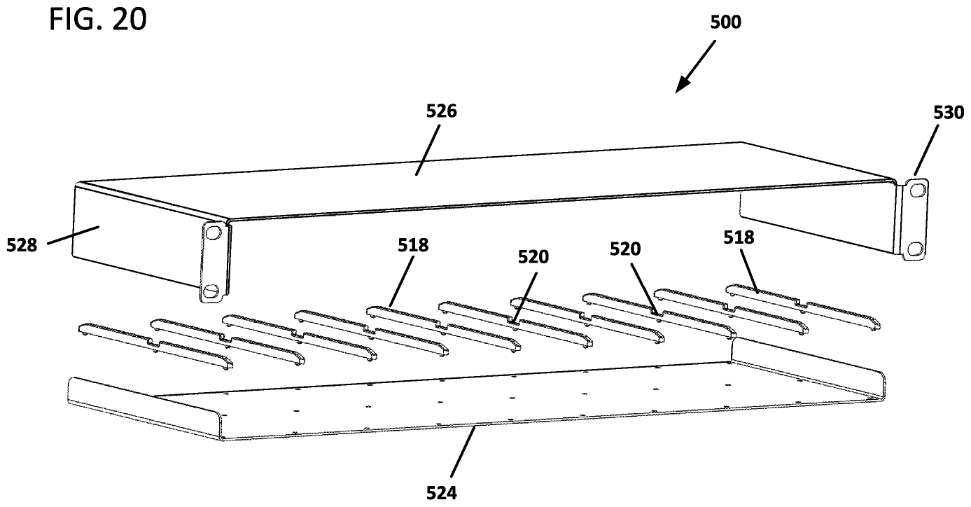

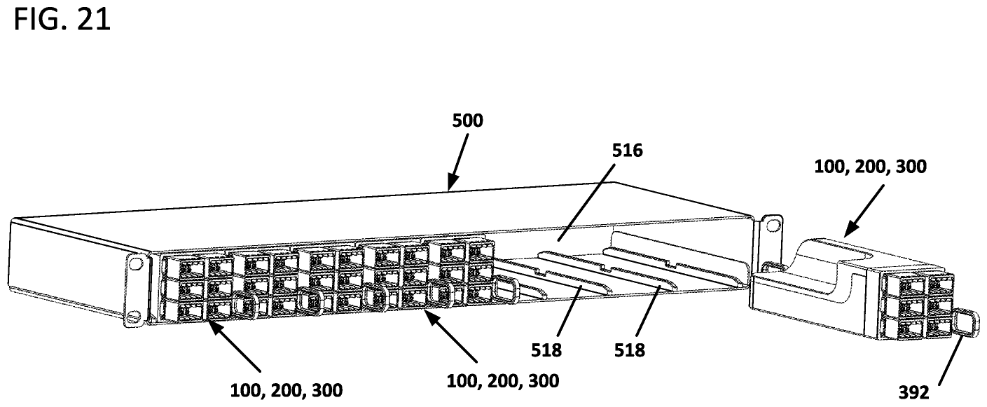

FIGS. 18-21 illustrate a first example implementation of a termination panel 500 including guides 518 defining a stop arrangement 520 at an intermediate position along the depth D of the panel 500. The guides 518 of termination panels 500, 600 are configured to engage a latching arrangement 390 carried by a cassette 100, 200, 300, 400 mounted within the panel 500, 600. An example latching arrangement 390 suitable for use with any of cassettes 100, 200, 300, 400 is shown in FIG. 13. The latching arrangement 390 aligns with one of the guides 518 when the cassette 100, 200, 300 is mounted within the panel 500, 600. The latching arrangement 390 includes a front handle 392, a stop 396, and a spring 398. The spring 398 biases the stop 396 to a locking position in which the stop 396 engages the stop arrangement 520 of the respective guide 518. Actuating (e.g., pulling, pushing, pivoting, lifting, etc.) the front handle 392 forwardly acts against the spring bias 398 to move the stop 396 to a releasing position relative to the stop arrangement 520. In certain examples, the latching arrangement 390 includes a rear handle 394 that moves the stop 396 to the releasing position when actuated. Examples of latching arrangements 390 and guides 518 suitable for use with the cassettes 100, 200, 300, 400 and panels 500, 600 disclosed herein are described in U.S. Provisional Application No. 63/209,571, filed Jun. 11, 2021, and titled “Cassette Latching Arrangements,” the disclosure of which is hereby incorporated by reference herein in its entirety.

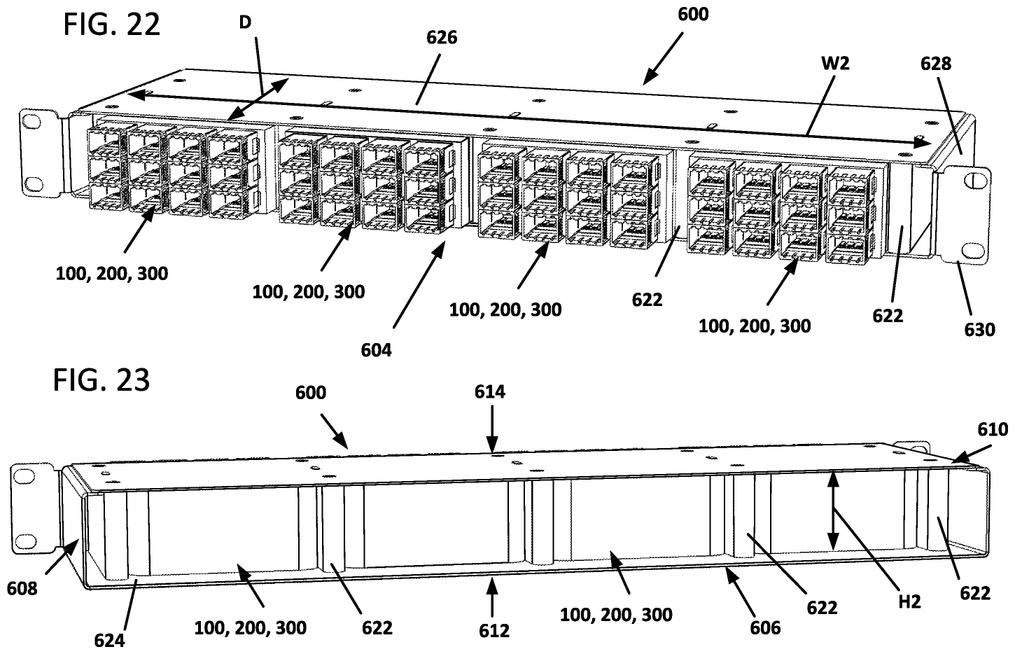

FIGS. 22-23 illustrate a second example implementation of a termination panel 600 in which spacer walls 622 divide the interior of the panel 600 into chambers. In certain examples, the spacer walls 622 extend along a majority of the depth D of the termination panel 600. In some implementations, multiple cassettes 100, 200, 300, 400 can be mounted within each interior chamber. In other implementations, only one cassette 100, 200, 300, 400 can be mounted within each interior chamber. One or more of the guides 518 are disposed within the interior chambers. In certain examples, multiple guides 518 are disposed within the interior chambers defined between adjacent spacer walls 622. In certain examples, no guides 518 are disposed between a spacer wall 622 and a sidewall 628. The spacer walls 622 provide rigidity to the termination panel 600 along the height H2 of the termination panel 600.

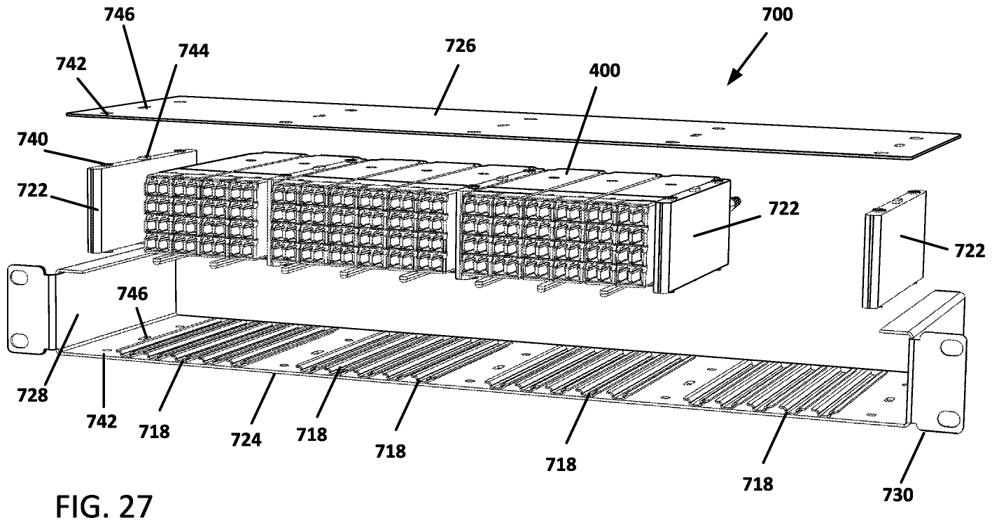

In certain examples, the spacer walls 622 are fastened to the top and bottom panels 626, 624. In certain examples, the spacer walls 622, 722 are fastened to the top and bottom panels 626, 624, 726, 724. For example, each spacer wall 622, 722 may define one or more fastener openings 740 that align with fastener openings 746 defined in the bottom and top panels 624, 626, 724, 726 (e.g., see FIG. 27). In certain examples, each spacer wall 622, 722 also may include one or more pegs 744 or holes that align with corresponding holes 746 or pegs of the bottom and/or top panels 624, 626, 724, 726 (e.g., see FIG. 27).

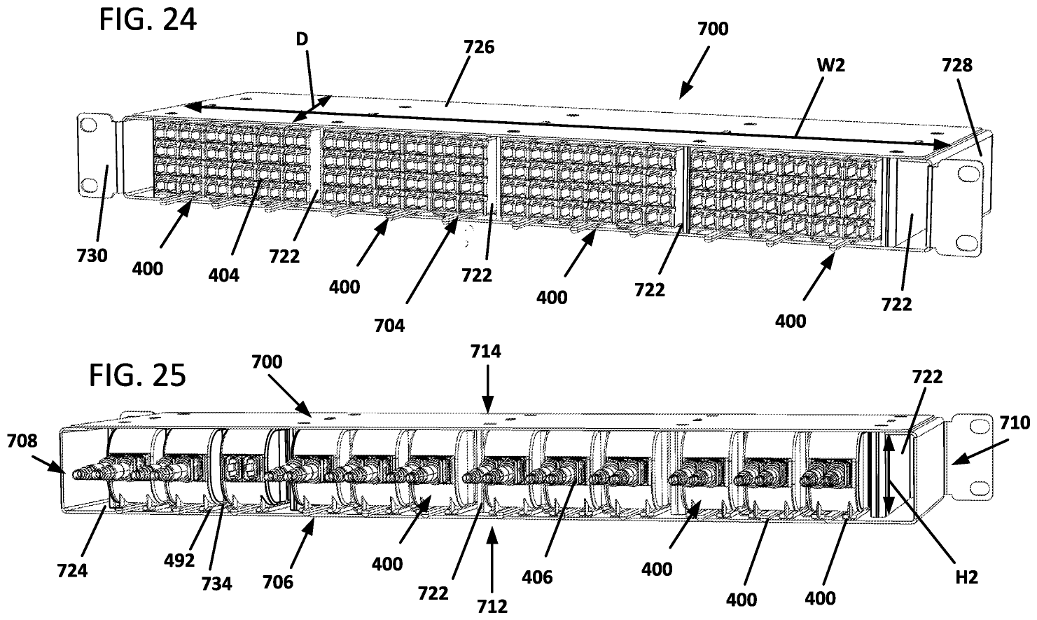

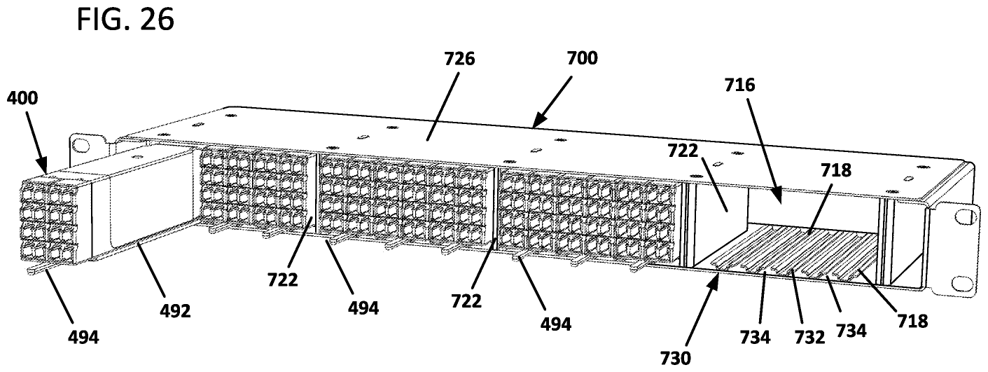

FIGS. 24-27 illustrate a third example implementation of a termination panel 700 in which the guides 718 define do not include a stop arrangement. Rather, the guides 718 form a first part 730 of an interlock arrangement configured to engage a second part 490 of the interlock arrangement carried by the cassettes 400. It will be understood that while the second part 490 of the interlock arrangement is shown on cassette 400, the second part 490 could instead of carried by any of the cassettes 100, 200, 300 thereby allowing the cassettes 100, 200, 300 to mount to the panel 700.

In certain implementations, the first part 730 of the interlock arrangement includes channels 734 defined by extensions 732 of the guide members 718 and the second part 490 includes rails 492 (FIG. 14) that fit within the channels 734 (e.g., see FIG. 25). In some implementations, each cassette 700 carries a plurality of parallel rails 492 that mount within adjacent channels 734. In other implementations, each cassette 700 carries only one rail 492. Engagement between the first and second parts 730, 490 of the interlock arrangement inhibits relative movement of the cassettes 400 and panel 700 along the width W2 and height H2 of the panel 700.

In some implementations, the interlock arrangement does not restrict movement along the depth D of the panel 700. In certain examples, the cassettes 400 carrying the second part 490 of the interlock arrangement include a forward pull handle 494 (FIG. 14) that enables a user to pull the cassette 400 along the guides 718 in a forward direction along the depth D of the panel 700. In certain examples, the forward pull handle 494 is fixedly mounted to the cassette body 402. In certain examples, the cassettes 400 carrying the second part 490 of the interlock arrangement include a rearward pull handle 496 that enables a user to pull the cassette 400 along the guides 718 in a rearward direction that is opposite the forward direction. In certain examples, the rearward pull handle 496 is fixedly mounted to the cassette body 402.

In certain implementations, the spacer walls 722 divide the interior of the panel 700 into chambers. In certain examples, the spacer walls 722 extend along a majority of the depth D of the termination panel 700. In some implementations, multiple cassettes 100, 200, 300, 400 can be mounted within each interior chamber. In other implementations, only one cassette 100, 200, 300, 400 can be mounted within each interior chamber. One or more of the guides 718 are disposed within the interior chambers. In certain examples, multiple guides 718 are disposed within the interior chambers defined between adjacent spacer walls 722. In certain examples, no guides 718 are disposed between a spacer wall 722 and a sidewall 728. The spacer walls 722 provide rigidity to the termination panel 700 along the height H2 of the termination panel 600.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A fiber cassette comprising:
a body extending along a depth between a front end and a rear end, the body defining an interior;
a first retainer disposed at the front end of the body, the first retainer being configured to hold forward port members in a plurality of columns, each column having more than one of the port members; and
a second retainer disposed at the rear end of the body, the second retainer being configured to hold at least one rearward port member.

2. The fiber cassette of claim 1, wherein the first retainer is configured to receive and retain the forward port members so that adjacent forward port members in each column directly oppose each other.

3. The fiber cassette of claim 1 or claim 2, wherein the second retainer is configured to hold a plurality of rearward port members.

4. The fiber cassette of claim 3, wherein the second retainer is configured to hold the rearward port members in a plurality of rows.

5. The fiber cassette of claim 3 or claim 4, wherein the second retainer is configured to snap-fit to the rear end of the body while carrying the rearward port members.

6. The fiber cassette of any of claims 1-5, wherein the first retainer is configured to snap-fit to the front end of the body while carrying the forward port members.

7. The fiber cassette of any of claims 1-6, wherein the body includes a base and a cover that cooperate to close the interior.

8. The fiber cassette of any of claims 1-6, wherein the body includes a base having an open top.

9. The fiber cassette of any of claims 1-8, further comprising a fiber manager disposed within the interior of the body, the fiber manager being configured to manage excess length of fibers extending between the forward port members and the rearward port member.

10. The fiber cassette of claim 9, wherein the fiber manager is configured to hold the excess length in a horizontal coil.

11. The fiber cassette of claim 9, wherein the fiber manager includes a drum configured to hold the excess length in a vertical coil.

12. The fiber cassette of any of claims 1-11, wherein the forward port members include SN adapters with vertically oriented ports.

13. The fiber cassette of any of claims 1-11, wherein the forward port members include MDC adapters with vertically oriented ports.

14. The fiber cassette of any of claims 1-11, wherein the forward port members include LC adapters with horizontally oriented ports.

15. The fiber cassette of any of claims 1-14, wherein the cassette carries a forward pull handle extending forwardly of the front end of the cassette and a rearward pull handle extending rearwardly of the rear end of the cassette.

16. The fiber cassette of claim 15, wherein the cassette includes a latching arrangement including a stop member movable between a retracted position and an extended position, the stop member being biased to the extended position, wherein movement of the forward pull handle and/or the rearward pull handle along the depth of the cassette while the stop member is disposed in the extended position moves the stop member to the retracted position.

17. A panel system comprising:
a chassis including a top panel and a bottom panel that each extend along a forward-rearward axis between a front end of the chassis and a rear end of the chassis, each of the top and bottom panels also extending along a lateral axis between opposite sidewalls of the chassis, the sidewalls extending along a height of the chassis between the top and bottom panels to define an interior, the height of the chassis being 1 RU, the top panel, bottom panel, and sidewalls being fixed relative to each other, the sidewalls having interior surfaces not configured to receive any additional panels or latching arrangements; and
a plurality of guides disposed at the bottom panel within the interior, the guides having lengths extending in parallel to each other along the forward-rearward axis, the guides being spaced apart along the lateral axis, each guide defining a stop arrangement at an intermediate position along the length.

18. The panel system of claim 17, wherein each stop arrangement includes a notch.

19. The panel system of claim 17, wherein each stop arrangement includes a flexible tab.

20. The panel system of any of claims 17-19, wherein the interior spans uninterrupted between the opposite sidewalls.

21. The panel system of any of claims 17-19, further comprising spacer walls disposed within the chassis and extending between the top and bottom panels to divide the interior.

22. The panel system of any of claims 17-21, further comprising a plurality of cassettes configured to mount within the interior of the chassis in a single row, each cassette carrying a latching arrangement configured to selectively engage the stop arrangement of a respective one of the guides when the cassette is mounted within the chassis, each cassette carrying a plurality of rows of front port members, each cassette spanning at least a majority of the height of the chassis.

23. The panel system of claim 22, wherein the front port members includes SN adapters.

24. The panel system of claim 23, wherein the SN adapters are configured to receive SN plug connectors in a vertically oriented position.

25. The panel system of claim 22, wherein the front port members includes MDC adapters.

26. The panel system of claim 25, wherein the MDC adapters are configured to receive MDC plug connectors in a vertically oriented position.

27. The panel system of claim 23, wherein the front port members includes duplex LC plug adapters.

28. The panel system of claim 22, wherein the cassettes have a common size regardless of the type of front port member carried.

29. The panel system of any of claims 22-28, wherein one of the cassette carries a rear port member optically coupled to the front port members.

30. The panel system of any of claims 22-28, wherein one of the cassettes is configured to receive a cable so that a first end of the cable is disposed within an interior of the cassette, the first end of the cable being optically coupled to the front port members.

31. The panel system of any of claims 22-28, wherein one of the cassettes is configured to receive a plurality of cables so that first ends of the cables are disposed within an interior of the cassette, the first ends of the cables being optically coupled to the front port members.

32. The panel system of any of claims 22-31, wherein the cassettes include the fiber cassette of any of claims 1-16.

33. A panel system comprising:
a chassis including a top panel and a bottom panel that each extend along a forward-rearward axis between a front end of the chassis and a rear end of the chassis, each of the top and bottom panels also extending along a lateral axis between opposite sidewalls of the chassis, the sidewalls extending along a height of the chassis between the top and bottom panels to define an interior, the height of the chassis being 1 RU, the top panel, bottom panel, and sidewalls being fixed relative to each other, the sidewalls having interior surfaces not configured to receive any additional panels or latching arrangements;
a plurality of guides disposed at the bottom panel within the interior, the guides having lengths extending in parallel to each other along the forward-rearward axis, the guides being spaced apart along the lateral axis; and
a plurality of cassettes configured to mount within the chassis, each of the cassettes having a bottom configured to engage at least one of the guides and a top configured to directly oppose the top panel of the chassis.

34. The panel of claim 33, further comprising spacer walls disposed within the interior of the chassis, the spacer walls being spaced apart along the lateral axis of the chassis to define chambers, each chamber including more than one of the guides.
